(19) United States
(12) Patent Application Publication
(10) Pub. No.: US 2012/0253940 A1
(43) Pub. Date: Oct. 4, 2012

(54) METHOD AND SYSTEM FOR DISTRIBUTION OF MOBILE COUPONS

(76) Inventors: Moshe Kibel, Cincinnati, OH (US); Leila Michal Kibel, Cincinnati, OH (US)

(21) Appl. No.: 13/510,693

(22) PCT Filed: Nov. 19, 2010
(86) PCT No.: PCT/US10/57457

§ 371 Date: May 18, 2012

Related U.S. Application Data
(60) Provisional application No. 61/263,037, filed on Nov. 20, 2009.

(51) Int. Cl. G06Q 30/02

(52) U.S. Cl. 705/14.64

(57) ABSTRACT

A method and system for distributing mobile coupons. The method includes providing a mobile coupon to a mobile communication facility; delivering a mobile coupon based on mobile user characteristics such that the mobile coupon may be displayed on the mobile user device; receiving a mobile coupon from mobile user device in order to redeem the mobile coupon; recording transaction in a data repository; and uploading transaction from data repository for analyzing mobile coupon distribution.

The present application generally relates to the distribution of mobile coupons. The present application more particularly relates to the ability of a point of sale to provide a mobile coupon to a mobile user device depending on relevant mobile user shopping characteristics determined by the retailer.

Currently, there are methods that allow retailers to post digital coupons on the Internet, which can then be seen by anyone who has the appropriate application software on their mobile device. There are also methods that transmit content to a mobile device based on user location.

However, the conventional methods do not provide a way for the retailer to transmit mobile coupons based on time of day, retailer decision, or mobile user shopping characteristics. Instead, the conventional methods focus either on the user actively seeking out suitable deals or on the user's location. Conventional methods also do not provide a mapping function showing particular stores within a retail environment and their respective mobile coupons.

Neither are concerned with the retailer's participation in providing mobile coupons to a mobile device. In another deficiency, the conventional methods do not give the retailer the ability to accurately record and analyze the distribution of mobile coupons, specifically as to the way certain mobile coupons were actually used, or related sales-tracking metrics. The conventional methods also only use a still picture form to deliver mobile coupons rather than using streaming video advertising data delivered to the user device.

The present application provides a method for distributing mobile coupons. The method may comprise providing a mobile coupon to a mobile communication facility; delivering a mobile coupon based on relevancy, wherein the relevancy is based on a mobile user such that the mobile coupon may be displayed on the mobile user device; and receiving a mobile coupon from mobile user device in order to redeem the mobile coupon. In one form, transactions can be recorded in a data repository; and uploaded from the data repository for analyzing mobile coupon distribution and other commercial indicia. Optionally, the providing may be performed in real time. The providing may also be performed by an access server. The access server may be a wireless router. In yet another option, the relevancy may be based upon user device proximity, time of day, retailer decision or mobile user shopping characteristics. Optionally, the displaying may include streaming video advertising data. Furthermore, the receiving may optionally include scanning an image of the mobile coupon from the screen of the user device to a scanning device signally coupled to the data repository. The receiving may include a barcode scan. It could also include displaying the mobile coupon. In another option, the recording may comprise a receipt. The receipt may be provided to the point of sale or to the user. The receipt may also determine mobile user shopping characteristics. Another option may include analyzing sales to determine mobile user shopping characteristics.

The present application also provides a mobile coupon processing system. The system may comprise an access server for transmitting mobile coupons; a payment module for collecting mobile coupons; a data repository for storing mobile coupons; and a processing component for uploading and analyzing mobile coupons for distribution at a point of sale. The access server may be a wireless router. The payment module may also be equipped with a memory and a display.

The present application further provides a method for distributing a mobile coupon. The method for distributing a mobile coupon may comprise providing a mobile coupon to a mobile communication facility; and delivering a mobile coupon to a user device based on prior shopping data associated with the user device. Optionally, the prior shopping data of the user device may be based on previous redemption of mobile coupons. In yet another option, the relevancy may comprise user device proximity.

The present disclosure will become more fully understood from the following detailed description, taken in conjunction with the accompanying figures, wherein like reference numerals refer to like elements, in which:

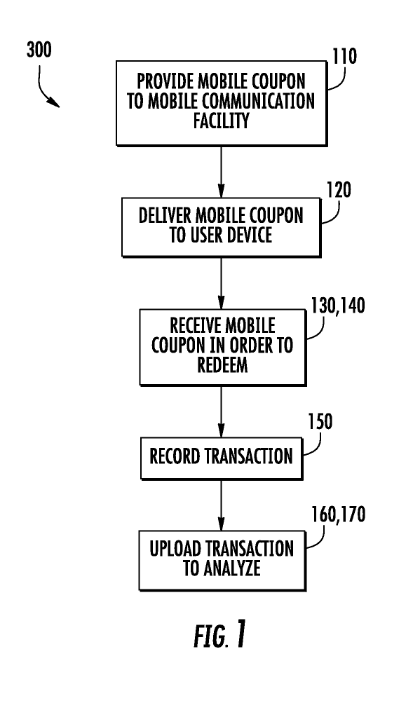

FIG. 1 is block diagram of a method for distributing mobile coupons;

FIG. 1A is a perspective view of a consumer in a retail shopping environment;

FIG. 1B illustrates a screen shot of a mobile device providing a mobile coupon based on a relevancy criteria according to an aspect of the present disclosure;

FIG. 1C illustrates a screen shot of a mobile device providing a mobile coupon based on a relevancy criteria according to an aspect of the present disclosure;

FIG. 1D illustrates a screen shot of a mobile device providing a mobile coupon based on a relevancy criteria according to an aspect of the present disclosure;

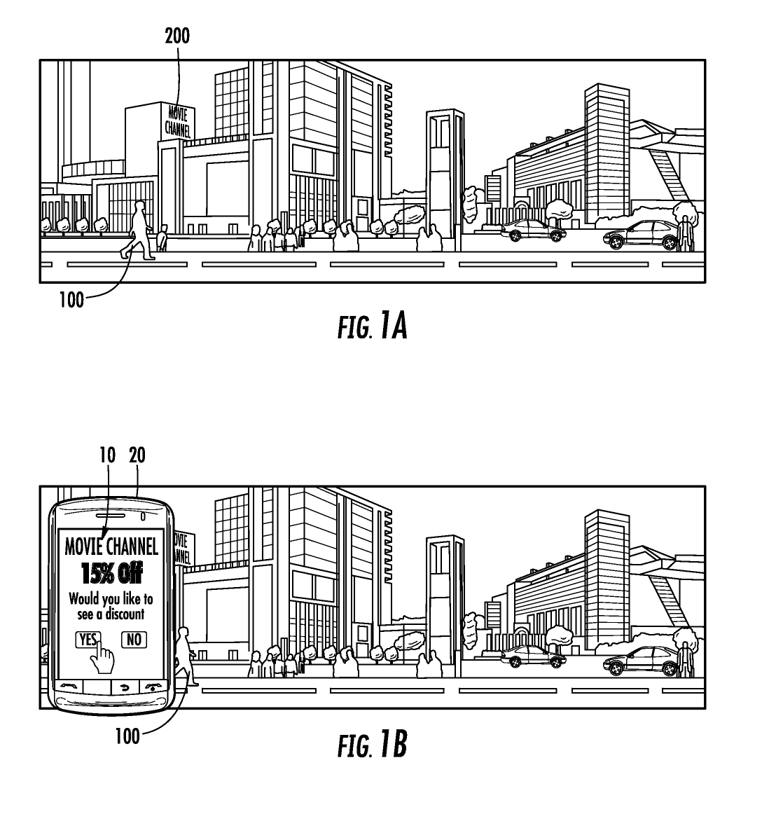

FIG. 2 is a simplified view of the text received via a mobile device, provided by a retailer;

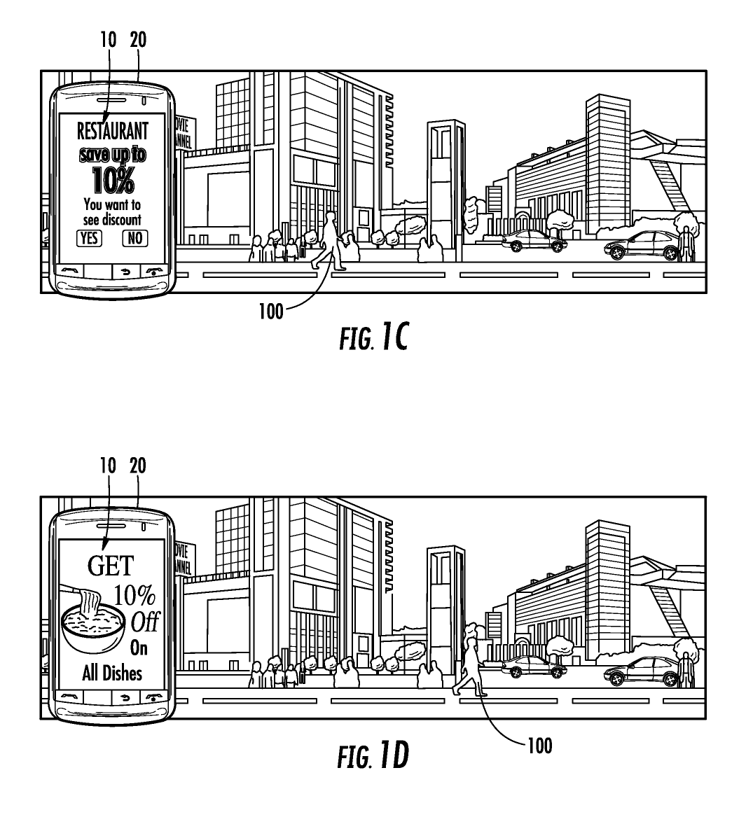

FIG. 3 is a simplified view of a map of a point of sale that is provided to a mobile device;

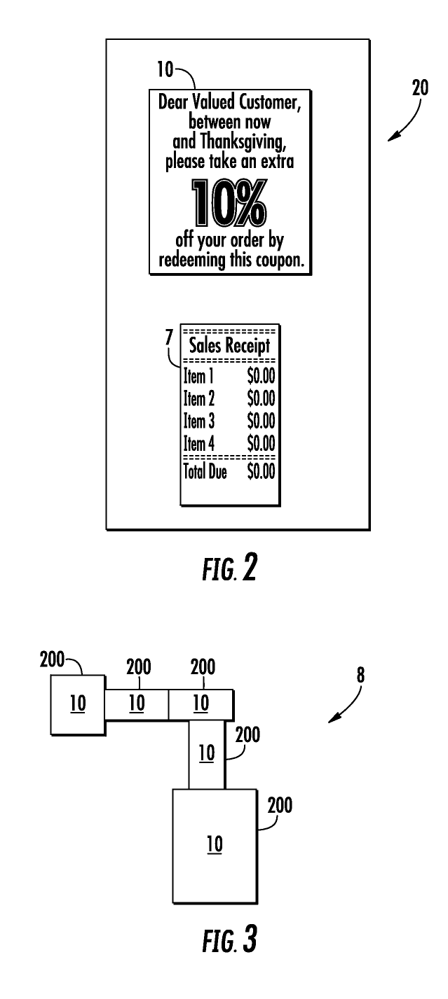

FIG. 4 is a simplified view of a display uploading a transaction from a data repository for analyzing mobile coupon distribution; and

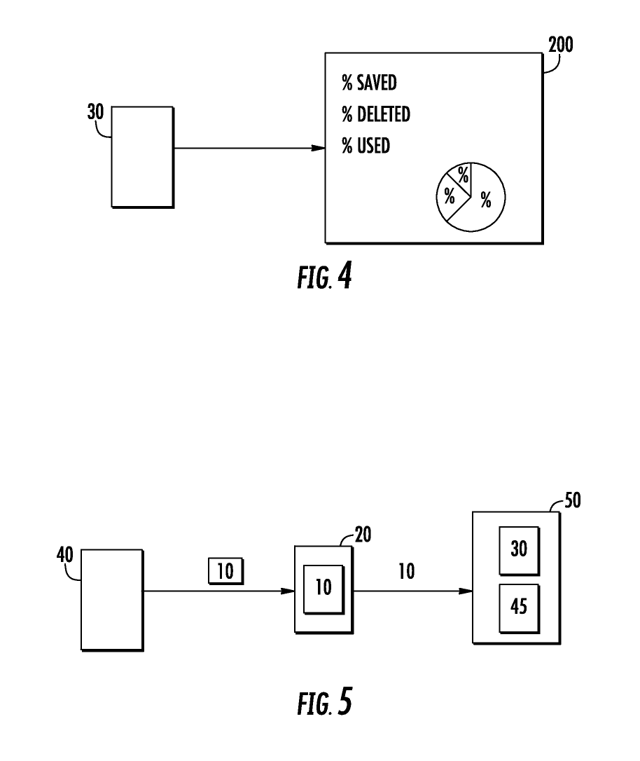

FIG. 5 is a block diagram of a mobile coupon processing system.

It should be understood that the application is not limited to the details or methodology set forth in the description or illustrated in the drawings. It should also be understood that the terminology is for the purpose of description only and should not be regarded as limiting.

Referring to FIGS. 1-1D, a user 100 is proximate to a point of sale 200. The point of sale 200 may include a single retail store, a number of retail stores, a strip mall, an outdoor retail center, a place of business, or the like. Method 300 may provide 110 a mobile coupon 10 to a mobile communication facility. The mobile communication facility can be an access server 40, a wireless router, an antenna, or any other hardware or software component that has the ability to provide or receive a signal. The mobile communication facility may be located at the point of sale 200, near the point of sale 200, away from the point of sale 200, or any location that has the ability to communicate with the point of sale 200. The providing 110 of the mobile coupon 10 may also be done in real time.

Referring with particularity to FIGS. 1 and 1A, method 300 may deliver 120 a mobile coupon 10 to a user device 20 based on relevancy such that the mobile coupon 10 may be displayed on the user device 20. Such relevancy may be based on mobile user shopping characteristics, which may include subscriber information such as age, gender, and so forth as well as relevant point of sale 200 information such as previous purchases, specific purchases, digital receipts, amount spent, mobile coupons 10 saved/deleted/used and so forth. Relevancy may also be based on other factors such as user proximity, time of day or a decision by the point of sale 200.

Referring with particularity to FIGS. 1-1B, method 300 may deliver 120 a mobile coupon 10 based on retailer decision. The point of sale 200 may be programmed to deliver mobile coupons 10 at specific intervals has increased sales by a certain percentage. A point of sale 200 may also be programmed to deliver mobile coupons 10 based on various sales strategies, statistics and other metrics. Therefore, the point of sale 200 may decide to send out a mobile coupon 10 once a triggering event that corresponds to such a time interval has occurred.

Referring with particularity to FIGS. 1 and 1C, method 300 may deliver 120 a mobile coupon 10 based on time. For example, a user device 20 having an internal or external timing mechanism may deliver a mobile coupon 10 based on the time of day. For example, a mobile coupon 10 with a lunch-time advertisement may be delivered between the hours of 11:30 a.m. and 1:00 p.m. to any user 100. In addition to time of day, the time could be related to the day, a season, a holiday or the subscriber characteristics, such as an anniversary, birthday, or the like.

The mobile coupon 10 may be displayed on the user device 20 using streaming video advertising data. It may also direct the user 100 to follow additional instructions, another link, or choose from a menu in order to obtain the mobile coupon 10.

Referring to FIGS. 1 and 2, method 300 may also deliver 120 a mobile coupon 10 using a text-based, rich-text format (RTF), or any other method known in the art for providing information to a user device 20.

A mobile coupon 10 may then be received 130 from the user device 20 in order to redeem 140 the mobile coupon 10. Redeeming 140 of the mobile coupon 10 may comprise a barcode scan by the point of sale 200. It may also include displaying or scanning the mobile coupon 10 from the user device 20. The mobile coupon 10 may be in any format in order for it to be redeemed 140, e.g., video, text, picture, sound, or any other technique used in the art for receiving information from a user device 20.

Referring to FIG. 1, the method 300 may then record 150 the transaction in a data repository 30. The data repository 30 may be memory, a server, a processor, a controller, or any other hardware or software component that has the ability to hold data for subsequent retrieval. Referring generally to FIG. 2, the recording 150 of the transaction may include a digital receipt 7 being provided to the user device 20 as well as to the point of sale 200. The point of sale 200 can use the digital receipt 7 to customize mobile coupons 10 based on mobile user shopping characteristics.

Referring to FIG. 3, the user 100 may obtain a map 8 of the point of sale 200 from the user device 20. The map 8 may include location of various points of sale 200, mobile coupons 10 for each point of sale 200, and other important locations, such as restrooms, food establishments, and the like.

Referring generally to FIGS. 1 and 4, the method 300 uploads 160 the transaction from the data repository 30 for analyzing 170 mobile coupon distribution. The point of sale 200 is able to determine which mobile coupons 10 were saved by the user device 20, which mobile coupons were used by the user device 20, and which mobile coupons 10 were deleted by the user device 20. Such information may be useful to a merchant, manufacturer or other entity within the stream of commerce as a way to analyze past commercial successes, as well as a way to plan for future promotions, sales and related commercial offerings.

Referring to FIG. 5, a block diagram showing an embodiment of a system capable of one embodiment of transmitting, receiving, collecting, holding, uploading and analyzing mobile coupons 10 for distribution at a point of sale 200. An access server 40 provides mobile coupons 10. The access server 40 may be a wireless router, an antenna, or any other hardware or software component that has the ability to provide or receive a signal. A payment module 50 collects mobile coupons 10. The payment module 50 may be equipped with a memory and a display, while a data repository 30 similar to that discussed above holds a record of the mobile coupons 10. The data repository 30 may be a component of the payment module 50 as shown in FIG. 5. It may also be a separate or stand-alone unit. The payment module 50 may also have a sensing component or other device to redeem a mobile coupon 10. The payment module 50 and the point of sale 200 may be connected by radio frequency, infrared link, wireless transceiver, or the like. A processing component 45 uploads the mobile coupons 10 for analyzing for distribution at a point of sale 200. The processing component 45 may be a computer module, a mobile computing device, or any other device that can upload and analyze mobile coupons 10. The processing component 45 may be equipped with a memory and a display. The processing component 45 may also be a component of the payment module 50 as shown in FIG. 5. It may also be a separate or stand-alone unit.

According to another aspect of the present disclosure, the mobile coupon 10 may be provided to a mobile coupon communication facility; and delivered to a user device 20 based on prior shopping data associated with the user device 20. The prior shopping data of the user device 20 may be based on previous redemption of mobile coupons 10 or other related indicia that the subscriber associated with the user device 20 has a prior relationship with the retail establishment that corresponds to the point of sale 200. The relevancy may also be based upon user device 20 proximity.

While the present disclosure has been particularly shown and described with reference to specific embodiments, it should be understood by those skilled in the art that various changes in form and detail may be made therein without departing from the spirit and scope of the disclosure as defined by the appended claims

1. A method for distributing mobile coupons, the method comprising:
providing a mobile coupon to a mobile communication facility;
delivering a mobile coupon to a user device based on relevancy such that the mobile coupon may be displayed on the user device;
receiving the mobile coupon from the user device in order to redeem the mobile coupon;
recording transaction in a data repository; and
uploading transaction from data repository for analyzing mobile coupon distribution.

2. The method of claim 1, wherein the providing is performed in real time.

3. The method of claim 1, wherein the providing is performed by an access server.

4. The method of claim 3, wherein the access server is a wireless router.

5. The method of claim 1, wherein the relevancy is selected from the group consisting of user device proximity, time of day, retailer decision and mobile user shopping characteristics.

6. The method of claim 1, wherein the displaying comprises streaming video advertising data.

7. The method of claim 1, wherein the receiving comprises scanning an image of the mobile coupon from the screen of the user device to a scanning device signally coupled to the data repository.

8. The method of claim 7, wherein the receiving comprises a barcode scan.

9. The method of claim 7, wherein the receiving comprises displaying the mobile coupon.

10. The method of claim 1, wherein the recording comprises a receipt.

11. The method of claim 10, wherein the receipt is provided to the point of sale.

12. The method of claim 11, wherein the receipt determines mobile user shopping characteristics.

13. The method of claim 10, wherein the receipt is provided to the user device.

14. The method of claim 1 further comprising analyzing sales to determine mobile user shopping characteristics.

15. A mobile coupon processing system comprising:
an access server for providing mobile coupons;
a payment module for collecting mobile coupons;
a data repository for holding mobile coupons; and
a processing component for uploading and analyzing mobile coupons for distribution at the point of sale.

16. The method of claim 15, wherein the access server is a wireless router.

17. The method of claim 15, wherein the payment module is equipped with a memory and a display.

18. A method for distributing a mobile coupon comprising:
providing a mobile coupon to a mobile communication facility; and
delivering a mobile coupon to a user device based on prior shopping data associated with the user device.

19. The method of claim 18, wherein the prior shopping data of the user device is based on previous redemption of mobile coupons.

20. The method of claim 18, wherein the relevancy further comprises user device proximity.
